(19) United States
(12) Patent Application Publication
(10) Pub. No.: US 2019/0232617 A1
(43) Pub. Date: Aug. 1, 2019

(54) RESIN METAL JOINT AND PRESSURE SENSOR

(71) Applicant: DENSO CORPORATION, Kariya-city (JP)

(72) Inventors: Motomi ISHIKAWA, Kariya-city (JP); Hiroyuki YAMAKAWA, Kariya-city (JP); Norihito YOSHIDA, Kariya-city (JP); Ryosuke IZUMI, Kariya-city (JP); Hodaka MORI, Kariya-city (JP)

(21) Appl. No.: 16/382,314

(22) Filed: Apr. 12, 2019

Related U.S. Application Data
(63) Continuation of application No. PCT/JP2017/032338, filed on Sep. 7, 2017.

(30) Foreign Application Priority Data
Oct. 20, 2016 (JP) 2016-205976

(51) Int. Cl. B32B 15/08; B32B 27/34; B32B 15/18; B32B 15/20; G01L 19/14; B29C 45/14

(52) U.S. Cl. CPC B32B 15/08; B32B 27/34; B29C 45/14311; B32B 15/20; G01L 19/14; B32B 15/18

(57) ABSTRACT

A plurality of micro-recess portions, which are recess portions each having a depth in a micron order, are provided on a metal surface. In addition, a plurality of nano-asperities, each of which is a recess and a protrusion having a height or a depth in a submicron order or a nano order, are formed on the metal surface. The micro-recess portions have a lower number of the nano-asperities than in a flat portion, which is a section of the metal surface that is different from the section where the micro-recess portions are provided.

### CROSS REFERENCE TO RELATED APPLICATIONS

The present application is a continuation application of International Patent Application No. PCT/JP2017/032338 filed on Sep. 7, 2017, which designated the U.S. and claims the benefit of priority from Japanese Patent Application No. 2016-205976 filed on Oct. 20, 2016. The entire disclosures of all of the above applications are incorporated herein by reference.

### TECHNICAL FIELD

The present disclosure relates to a resin metal joint and a pressure sensor including the resin metal joint.

### BACKGROUND

In a resin metal joint, a metal surface has an asperous surface in a micron order. On the asperous surface in a micron order, asperities are provided at an interval of 1 to 10 μm. The height difference of the asperities is formed to be in an half of the interval. In addition, on an inner wall surface of a recess portion (hereinafter referred to as a “micro-recess portion”) of the asperous surface, fine asperous surfaces provided at an interval of 10 to 500 nm are formed. Thus, stronger and rigid bonding between the metal surface and the synthetic resin is attained.

Although it is difficult for a synthetic resin material, which is for configuring a synthetic resin member, to intrude into a recess portion (hereinafter referred to as a “nano-recess portion”) of the fine asperous surface, the synthetic resin material intrudes into a part of several nano-recess portions in some extent. Thus, the satisfactory bonding strength can be attained.

### SUMMARY

The present disclosure provides a resin metal joint as a joint between a metal surface and a synthetic resin member, and a pressure sensor including the resin metal joint. The resin metal joint includes: a plurality of micro-recess portions on the metal surface; a flat portion as a section of the metal surface; and a plurality of nano-asperities on the metal surface.

### BRIEF DESCRIPTION OF DRAWINGS

The above and other objects, features and advantages of the present disclosure will become more apparent from the following detailed description made with reference to the accompanying drawings. In the drawings:

FIG. 1 is a cross-sectional view showing a schematic configuration of a pressure sensor according to an embodiment;

FIG. 2 is an enlarged cross-sectional view showing a schematic configuration of a resin metal joint related to the embodiment;

FIG. 3A is an enlarged cross-sectional view of an example of a metal surface illustrated in FIG. 2;

FIG. 3B is an enlarged cross-sectional view of another example of the metal surface illustrated in FIG. 2;

FIG. 3C is an enlarged cross-sectional view of a further example of the metal surface illustrated in FIG. 2; and

FIG. 4 is an enlarged cross-sectional view of the resin metal joint related to a modified example.

### DETAILED DESCRIPTION

Voids are generated in a joint portion between a metal surface and a synthetic resin member. The voids are generated because a synthetic resin material does not intrude into a nano-recess portion of the metal surface. A large number of the generated voids degrade the air leakage efficiency or the liquid leakage efficiency of the joint portion. This type of joint may be arranged to face a fluid to be measured or a pressure transmitting fluid in a pressure sensor, which generates an electrical output corresponding to the pressure of the fluid. In this situation, a fault such as the intrusion of fluid into the joint portion or the leakage of fluid to outside of the sensor may happen due to the degradation of the air leakage efficiency or the liquid leakage efficiency of the joint portion.

A resin metal joint according to a first aspect of the present disclosure is a joint between a metal surface and a synthetic resin member.

The resin metal joint includes: a plurality of micro-recess portions provided at the metal surface, the micro-recess portions each being a recess portion having a depth in a micron order; a flat portion provided on the metal surface that is different from the micro-recess portions; a plurality of nano-asperities provided at the metal surface, the nano-asperities each being a protrusion and a recess having a height or a depth in a sub-micron order or a nano order. The micro-recess portion has a lower number of the nano-asperities than in the flat portion.

In the forming of the joint, the synthetic resin material, which is for configuring the synthetic resin member, intrudes into the micro-recess portion while adhering to the flat portion. Thus, stronger and rigid bonding between the metal surface and the synthetic resin member can be attained because of the asperities in a micron order, which are formed on the entire metal surface, as the micro-recess portion and the nano-asperities formed on the flat portion.

The voids may be generated at the joint portion between the metal surface and synthetic resin member due to the non-intrusion of the synthetic resin material to the inner side of the nano-recess portion, which is for configuring the nano-asperity. In particular, the voids are easily generated inside the micro-recess portion. In this respect, in the above-mentioned configuration, fewer nano-asperities are provided on the micro-recess portion of the metal surface. Therefore, the voids are hardly to be generated between the surface of the micro-recess portion and the synthetic resin member.

On the other hand, the synthetic resin material easily intrudes into the nano-asperities formed on a portion (such as the flat portion), which is different from the inner side of the micro-recess portion of the metal surface. Therefore, even though a number of the nano-asperities are formed on the flat portion, the voids are hardly to be generated between the surface of the flat portion and the synthetic resin member.

As described above, the generation of the voids at the joint portion can be inhibited as expeditiously as practical. According to the above-mentioned configuration, it is possible to achieve stronger and rigid bonding between the metal surface and the synthetic resin member while improving the air leakage efficiency or the liquid leakage efficiency of the joint portion.

A pressure sensor according to a second aspect of the present disclosure is configured to generate an electrical output corresponding to the pressure of a fluid. The pressure sensor includes the resin metal joint provided to face the fluid.

In the pressure sensor having the above-mentioned configuration, the satisfactory air leakage efficiency or liquid leakage efficiency of the joint portion of the resin metal joint can be achieved. Therefore, even though the resin metal joint faces the fluid, the intrusion of the fluid to the joint portion or the leakage of the fluid can be satisfactorily inhibited.

Hereinafter, embodiments will be described with reference to the drawings. A variety of modifications applicable to the embodiments are described as modified examples following the description of the embodiments.

(Configuration of Pressure Sensor)

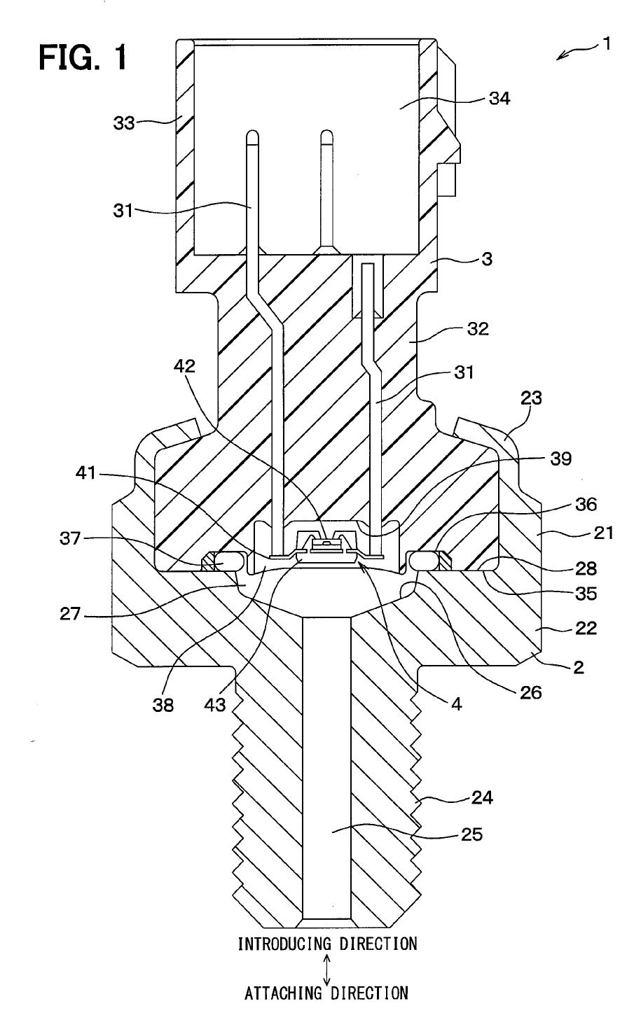

Referring to FIG. 1, a pressure sensor 1 related to the present embodiment is a fluid pressure sensor mounted on a vehicle, and is configured to generate an electrical signal (for example, a voltage) corresponding to a fuel pressure, a brake fluid pressure or the like inside a vehicle. In particular, the pressure sensor 1 includes a housing 2, a connector case 3 and a sensing part 4.

Hereinafter, the upward direction in FIG. 1 will be referred to as an “introducing direction,” and the downward direction in FIG. 1 will be referred to as an “attaching direction.” The introducing direction is the direction in which the fluid as a pressure measurement target such as fuel and brake fluid is introduced into the pressure sensor 1. The fluid as the pressure measurement target is referred to as a “fluid to be measured” hereinafter. An attaching direction is the direction in which the pressure sensor 1 is attached to, for example, a pipe in which the fluid to be measured is present. Additionally, a view of the target with the line of sight in the attaching direction is referred to as “planar view,” and a view of the target with the line of sight in the introducing direction is referred to as “bottom view.”

The housing 2 is a metallic cylindrical member having a central axis parallel to the introducing direction, and includes a device accommodating portion 21, a flange portion 22, a crimping portion 23 and a fluid introducing portion 24. The device accommodating portion 21, the flange portion 22, the crimping portion 23 and the fluid introducing portion 24 are integrally formed without a seam. The central axis of the housing 2 may also be grasped as the central axis of the pressure sensor 1. Therefore, the central axis of the pressure sensor 1 and the housing 2 is referred to as “sensor central axis” hereinafter.

The device accommodating portion 21 is formed in a cylindrical shape, and an end portion of the device accommodating portion 21 on the attaching direction side is connected to the flange portion. That is, the device accommodating portion 21 protrudes toward the introducing direction from the outer periphery of the flange portion 22. The flange portion 22 is a plate-like portion disposed to be perpendicular to the sensor central axis, and is provided to close the end portion of the cylindrical device accommodating portion 21 on the attaching direction side.

The crimping portion 23 is a thin-walled portion, and further protrudes toward the introducing direction from the device accommodating portion 21. The crimping portion 23 is bent toward the sensor central axis so as to be crimped to the end portion of the connector case 3 accommodated in the space inside the device accommodating portion 21.

The fluid introducing portion 24 is a cylindrical portion having threads provided on its outer periphery, and protrudes toward the attaching direction from the central portion in the planner view of the flange portion 22. An introduction hole 25 as a through hole is provided along the sensor central axis in the fluid introducing portion 24. The end portion of the introduction hole 25 on the introducing direction side is open at an introduction recess portion 26 provided in the flange portion 22. The introduction recess portion 26 is provided so as to open toward the introducing direction. The measurement space 27, which is the space on the inner side of the introduction recess portion 26, is connected to the introduction hole 25. That is, the measurement space 27 is provided so that the fluid to be measured can be introduced through the introduction hole 25.

The support surface 28, which is an end surface of the flange portion 22 on the introducing direction side, is provided to face the space inside the device accommodating portion 21. The support surface 28 is a smooth surface perpendicular to the introducing direction, and is provided outside the introduction recess portion 26 in the planar view.

The connector case 3 includes a terminal member 31 and a resin portion 32. The terminal member 31 is a rod-like member made of a metal, and is disposed so that its longitudinal direction is parallel to the introducing direction. In the present embodiment, the connector case 3 is provided with a plurality of terminal members 31.

The connector case 3 is formed to cover the surrounding of the terminal member 31 with a resin portion 32 by, for example, insert molding. A connector attaching portion 33, which is an end portion of the resin portion 32 on the introducing direction side, is formed in a bottomed cylindrical shape open toward the introducing direction. That is, the connector attaching portion 33 is provided with an attaching hole 34. The attaching hole 34 is formed so that the end portion of the terminal member 31 on the introducing direction side is exposed to outside the resin portion 32.

The sealing surface 35, which is an end surface of the connector case 3 on the attaching direction side, is a smooth surface perpendicular to the attaching direction, and is formed to face the support surface 28 of the housing 2. A sealing groove 36 formed in a ring shape is provided to surround the sensor central axis at the sealing surface 35 in a bottom surface view. The sealing groove 36 is formed so that the sealing member 37 such as an O-ring can be attached.

The accommodating recess portion 38 is formed inside the sealing groove 36, that is, on the sensor central axis side in the bottom view. The accommodating recess portion 38 is open toward the attaching direction, and is provided to face the measurement space 27. The accommodating recess portion 38 is formed so that the end portion of the terminal member 31 on the attaching direction side is exposed to outside the resin portion 32. That is, the end portion of the terminal member 31 on the attaching direction side is protruded from a terminal exposing surface 39 as an inner wall surface of the accommodating recess portion 38 toward the attaching direction. The terminal exposing surface 39 is a wall surface defining the end portion of the accommodating recess portion 38 on the introducing direction side, and is provided to face the introducing recess portion 26.

The sensing part 4 generates an electrical output corresponding to the pressure of the fluid to be measured introduced into the measurement space 27. The sensing part 4 includes a lead frame 41, a sensor element 42 and a resin case 43.

The lead frame 41 is a plate member made of a satisfactory conductive metal such as copper, and is extended in a direction intersecting the introducing direction. The sensor element 42 is mounted substantially at a central portion of the lead frame 41 in the planar view. The sensor element 42 has a diaphragm (not shown) and a gauge resistor (not shown) formed on the diaphragm. The sensor element 42 is electrically connected to the lead frame 41 by, for example, wire bonding. The resin case 43 is provided so as to cover the sensor element 42 while exposing the outer periphery of the lead frame 41 to outside. The outer periphery of the lead frame 41 exposed from the resin case 42 is electrically connected to the terminal member 31 by being joined with the end portion of the terminal member 31 on the attaching direction side.

The pressure sensor 1 is configured to be attached to, for example, a pipe in which the fluid to be measured is present. That is, in a situation where the pressure sensor 1 is attached to, for example, the pipe, the pressure sensor 1 is configured such that the fluid to be measured is introduced into the measurement space 27 through the introduction hole 25, and an electrical signal corresponding to the pressure of the fluid to be measured inside the measurement space 27 is output.

(Configuration of Resin Metal Joint)

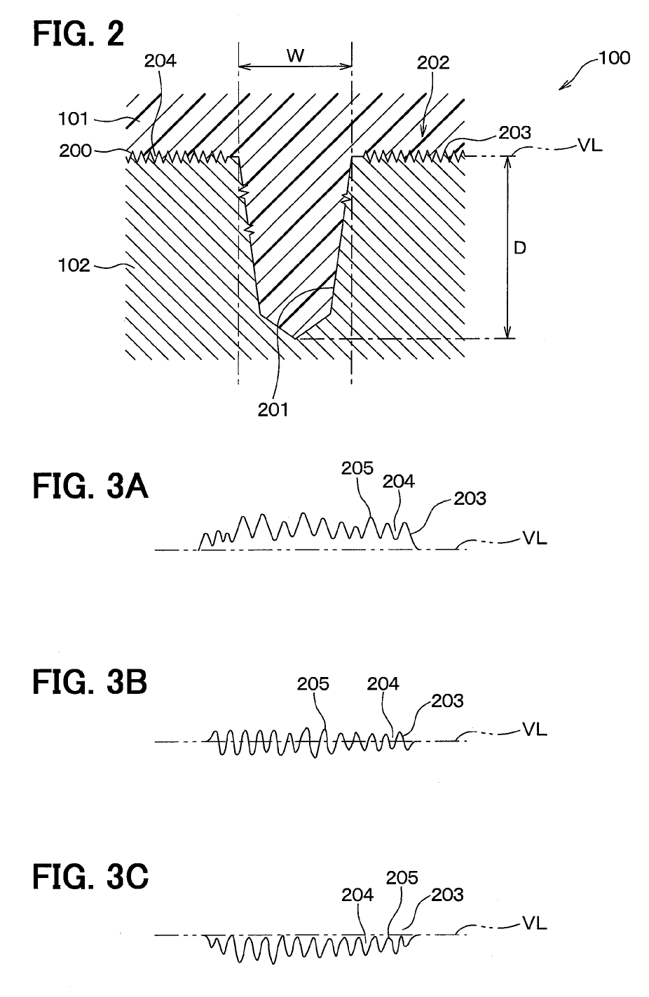

Referring to FIG. 2, a resin metal joint 100 is formed as a joint between a synthetic resin member 101 and a metal portion 102. The metal portion 102 is a metal member such as the terminal member 31 or the lead frame 41, and has a metal surface 200. That is, the resin metal joint 100 may correspond to the connector case 3 as a joint between the terminal member 31 and the resin portion 32 in FIG. 1. Alternatively, the resin metal joint 100 may correspond to the sending part 4 as the joint of the lead frame 41 and the resin case 43 in FIG. 1.

The following describes the configuration of the resin metal joint 100 related to the present embodiment in detail with reference to FIG. 2, FIG. 3A, FIG. 3B, and FIG. 3C. As shown in FIG. 2, a plurality of micro-recess portions 201, each of which is a recess portion having a depth in a micron order (for example, 50 to 100 μm), are provided at the metal surface 200. A flat portion 202 is provided around the micro-recess portion 201. That is, in the present embodiment, the flat portion 202 is different from the micro-recess portion 201, in particular, a portion other than the micro-recess portion 201.

The micro-recess portion 201 is formed as a deep groove or hole. That is, the micro-recess portion 201 has a substantially V-shaped cross-sectional shape or a substantially U-shaped cross-sectional shape. In other words, when the depth of the micro-recess portion 201 represents D and the opening width of the micro-recess portion 201 represents W, the micro-recess portion 201 is formed to satisfy a relation of 1≤D/W≤5. In particular, the micro-recess portion 201 is formed such that the opening width W is 20 to 50 μm when the depth D is 50 to 100 μm. The respective definitions of the “depth” and “opening width” of the micro-recess portion 201 are described hereinafter.

On the metal surface 200, a plurality of nano-asperities 203 each having a height or a depth in a submicron order or nano order are provided. The nano-asperities 203 have a large number of nano-recess portions 204 and a large number of nano-protrusion portions 205.

In the present embodiment, the nano-asperities 203 are mainly provided on the flat portion 202. That is, the micro-recess portion 201 has fewer nano-asperities 203 than in the flat portion 202. In other words, the roughness of the nano-asperities 203 of the micro-recess portion 201 is smaller than that of the flat portion 202. The respective definitions of “height” and “depth” of the nano-asperity 203 are mentioned hereinafter.

Specifically, the nano-asperities 203 are hardly formed on the micro-recess portion 201, or are not formed at all on the micro-recess portion 201. That is, the density of nano-asperities 203 of the micro recess portion 201 is lower than that of the nano-asperities 203 of the flat portion 202.

Furthermore, in a situation where the micro-recess portion 201 has the nano-asperities 203, the height of each of the nano-asperities 203 of the micro-recess portion 201 is smaller than the height of each of the nano-asperities 203 of the flat portion 202. Similarly, in a case where the micro-recess portion 201 has the nano-asperities 203, the depth of each of the nano-asperities 203 of the micro-recess portion 201 is shallower than the depth of each of the nano-asperities 203 of the flat portion 202. Specifically, for example, in a situation where the height or depth of each of the nano-asperities 203 of the flat portion 202 is 100 to 500 nm, each of the nano-asperities 203 of the micro-recess portion 201 is formed such that the height or the depth is less than 100 nm.

(Definition)

The depth and the opening width of the micro-recess portion 201 may be defined as follows. The virtual planar surface of the flat portion 202 in a situation where the nano-asperities 203 of the flat portion 202 are smoothed, in other words, in a situation where the nano-asperities 203 are not formed, is referred to as “virtual outline VL” at the cross-sectional drawing such as FIG. 2. In this situation, the depth of the micro-recess portion 201 is a distance between the virtual outline VL and the bottom portion of the micro-recess portion 201 in a normal line direction (that is, the vertical direction in FIG. 2) of the virtual surface.

The micro-recess portion 201 may be a hole whose planar shape has a substantially circular shape or a substantially elliptical shape. The planar shape refers to the outer shape when the line of sight is viewed as the above-mentioned normal direction. In this situation, the opening width of the micro-recess portion 201 is the outermost diameter of the planar shape of the micro-recess portion 201.

The micro-recess portion 201 may be a hole whose planar shape is polygonal or irregular. In this situation, the opening width of the micro-recess portion 201 is the diameter of the smallest circumscribing circle including the planar shape of the micro-recess portion 201.

The micro-recess portion 201 may be a groove. In this situation, the opening width of the micro-recess portion 201 is the maximum dimension of the micro-recess portion 201 in the groove width direction. The groove width direction is perpendicular to the depth direction defining the depth of the groove, and is perpendicular to the longitudinal direction of the groove.

FIGS. 3A, 3B and 3C indicate the difference in the formation method and formation mode of the micro-recess portion 201 and the nano-asperities 203 illustrated in FIG. 2. The following describes the relationship between the virtual outline VL and the nano-asperities 203 and the definition of, for example, height of the nano-asperity 203 with reference to FIGS. 2, 3A, 3B and 3C. In FIGS. 3A, 3B and 3C, hatching showing a metal cross section is omitted for simplicity of illustration.

For example, when the micro-recess portion 201 is formed by laser irradiation, the metal at a portion corresponding to the micro-recess portion 201 is once vaporized. The vaporized metal and/or a compound thereof (for example, oxide) is deposited inside the micro-recess portion and on the flat portion 202 around the micro-recess portion 201 so that the nano-asperity 203 is formed. In this situation, the virtual outline VL is the outline of the metal surface 200 in the cross-sectional view immediately before the nano-asperity 203 is deposited. In particular, the virtual outline VL at the position of the flat portion 202 is an outline in the cross-sectional view of the flat portion 202 before the step of forming the micro-recess portion 201 by laser irradiation. As shown in FIG. 3A, the nano-recess portion 204 and the nano-protrusion portion 205 in the nano-asperity 203 are formed above the virtual outline VL.

In FIG. 3A, the height of the nano-asperity 203 is an average value of ten measurements in a situation where “the height of the peak of the nano-protrusion portion 205 from the virtual outline VL” is determined within the predetermined dimension of the virtual outline VL in the cross-sectional view. The predetermined dimension is 10 μm. The predetermined dimension is the same as in FIGS. 3B and 3C, which will be described later. “The peak of the nano-protrusion portion 205” is an end point, which is the farthest from the virtual outlie VL. That is, “the height from the virtual outline VL of the peak of the nano-protrusion portion 205” is the distance from the virtual outline VL to the peak of the nano-protrusion portion 205 in the vertical direction, which is illustrated in the drawing, perpendicular to the virtual outline VL.

In FIG. 3A, the depth of the nano-asperity 203 is calculated such that ten continuous sets of the nano-recess portion 204 and the nano-protrusion portion 205 adjacent to each other along the virtual outline VL in a cross-sectional view are extracted within the predetermined dimension of the virtual outline VL. In particular, in each pair, “the height of the peak of the nano-protrusion portion 205 from the virtual outline VL” and “the height of the bottom of the nano-recess portion 204 from the virtual outline VL” are calculated so that the depth of the nano-recess portion 204 in each set can be obtained. “The bottom of the nano-recess portion 204” is the end point of the nano-recess portion 204 closest to the virtual outline VL in FIG. 3A. “The height of the bottom of the nano-recess portion 204 from the virtual outline VL” is the distance from the virtual outline VL to the bottom of the nano-recess portion 204 in the vertical direction (shown in the drawing) perpendicular to the virtual outline VL. The depth of the nano-asperity 203 is an average value of the depths of the nano-recess portions 204 in each set.

For example, in a situation where the nano-asperity 203 is formed by, for example, blast processing, the nano-asperity 203 is formed so as to bridge over the virtual outline VL. That is, the peak of the nano-protrusion portion 205 is on the upper side of the virtual outline VL, and the bottom of the nano-recess portion 204 is on the lower side of the virtual outline VL. In this situation, “the bottom of the nano-recess portion 204” is an end portion, which is the farthest from the virtual outline VL.

In FIG. 3B, the height of the nano-asperity 203 is calculated by extracting ten continuous sets of the nano-recess portion 204 and the nano-protrusion portion 205 adjacent to each other along the virtual outline VL within the predetermined dimension of the virtual outline VL. In particular, the height of the nano-protrusion portion 205 can be obtained by adding the “depth of the bottom of the nano-recess portion 204 from the virtual outline VL” to the “height of the peak of the nano-protrusion portion 205” for each set. “The depth of the bottom of the nano-recess portion 204 from the virtual outline VL” is the distance from the virtual outline VL to the bottom of the nano-recess portion 204 in the vertical direction in the drawing perpendicular to the virtual outline VL. The height of the nano-asperity 203 is an average value obtained from the height of the nano-protrusion portion 205 in each set. That is, the height of the nano-asperity 203 is an average value obtained from the height, which is from the bottom of the nano-recess portion 204 to the peak of the nano-protrusion portion 205 in each set.

For example, in a situation where the nano-asperity 203 is formed by chemical etching or the like, the virtual outline VL is the outline of the metal surface 200 in the cross sectional view before the formation of the nano-asperity 203. As shown in FIG. 3C, the nano-recess portion 204 and the nano-protrusion portion 205 in the nano-asperity 203 are formed below the virtual outline VL.

In FIG. 3C, the depth of the nano-asperity 203 is an average value evaluated by ten sets of “the depth of the bottom of the nano-recess portion 204 from the virtual outline VL” within the predetermined dimension of the virtual outline VL in the cross-sectional view. The definition of the “bottom of the nano-recess portion 204” is similar to the one in FIG. 3B.

The height of the nano-asperity 203 is calculated by extracting ten continuous sets, each of which has the nano-recess portion 204 and the nano-protrusion portion 205 adjacent to each other along the virtual outline VL in the cross-sectional view, within the predetermined dimension of the virtual outline VL. In particular, the height of the protrusion portion 205 in each set is obtained by calculating the difference between “the depth of the bottom of nano-recess portion 204 from the virtual outline VL” and “the depth of the peak of the nano-protrusion portion 205 from the virtual outline VL.” “The peak of the nano-protrusion portion 205” is an end point of the nano-protrusion portion 205 closest to the virtual outline VL. “The depth of the peak of the nano-protrusion portion 205 from the virtual outline VL” is the distance from the virtual outline VL to the peak of the nano-protrusion portion 205 in the vertical direction (in the drawing) perpendicular to the virtual outline VL. The height of the nano-asperity 203 is an average value obtained from the height of the nano-protrusion portion 205 in each set. That is, the height of the nano-asperity 203 is an average value obtained from the height, which is from the bottom of the nano-recess portion 204 to the peak of the protrusion portion 205 in each set.

“Large number” of the nano-asperities 203, “small number” of the nano-asperities 203 and “the magnitude of roughness” of the nano-asperities 203 can be evaluated by the formation degree of the nano-asperities 203. For example, “large number” and “small number” of the nano-asperities 203 can be evaluated primarily by the “density” of the nano-asperities 203. That is, in a situation where the density of the nano-asperities 203 in the region A is lower than the density of the nano-asperities 203 in the region B, it can be said that the region A has a lower density in nano-asperities 203 than the region B. Similarly, in this situation, it can be said that the region A has the smaller “roughness” of the nano-asperities 203 than the region B. It is noted that the “density” of the nano-asperities 203 is the number of nano-recess portions 204 or the nano-protrusion portions 205 in each unit area.

On the other hand, it is assumed that the “density” of the nano-asperities 203 is the same in the regions A and B. Even with such a configuration, in a situation where the height of the nano-asperity 203 in the region A is lower than the height of the nano-asperity 203 in the region B, it can be said that the region A has a lower number of the nano-asperities than the region B. Similarly, in this situation, it can be said that the region A has a smaller roughness of the nano-asperities 203 than the region B.

(Manufacturing Method)

As the synthetic resin material for configuring the synthetic resin member 101, for example, a thermoplastic resin such as polypropylene sulfide, polyphenylene sulfide, polybutylene terephthalate, polyethylene terephthalate and polyamide may be used. Alternatively, as the synthetic resin material for configuring the synthetic resin member 101, for example, a thermosetting resin such as a phenol resin, a melamine resin, an epoxy resin may be used. As the metal material for configuring the metal portion 102, for example, an alloy having at least one of, for example, aluminum, copper, iron, or the combination of these elements may be used.

The micro-recess portion 201 may be formed by any processing method such as laser irradiation, chemical etching, electric discharge processing, press processing, rolling processing or cutting processing. The nano-asperity 203 may be formed by any processing method such as laser irradiation, chemical etching or blast processing. The method for forming the synthetic metal joint 100 as the joint between the synthetic resin member 101 and the metal portion 102 after forming the micro recess portion 201 and the nano-asperity 203 may be formed by any processing method such as insert molding or thermo-compression bonding.

### Advantages of Embodiments

In the step for forming the resin metal joint 100, the synthetic resin material, which is for configuring the synthetic resin member 101, intrudes into the micro-recess portion 201 while closely adhering to the flat portion 202. The asperity in a micron order formed on the entire metal surface 200 by the micro-recess portion 201 and the nano-asperity 203 formed on the flat portion 202 provide stronger bonding between the metal surface 200 and the synthetic resin member 101.

At this time, the voids may be generated at the joint portion between the metal surface 200 and the synthetic resin member 101 due to the non-intrusion of the synthetic resin material into the nano-recess portion 204 for configuring the nano-asperity 203. In particular, such voids easily are generated inside the micro-recess 201. In this respect, in the above-mentioned structure, there are fewer nano-asperities 203 on the micro-recess portion 201 of the metal surface 200. Therefore, the voids are hardly to be generated between the surface of the micro-recess portion 201 and the synthetic resin member 101.

On the other hand, the synthetic resin material hardly intrudes into the nano-recess portion 204 formed on the flat portion 202. Therefore, even though many nano-asperities 203 are provided on the flat portion 202, the voids are hardly to be generated between the surface of the flat portion 202 and the synthetic resins member 101.

As described above, in the configuration of the present embodiment, the generation of voids at the joint portion between the metal surface 200 and the synthetic resin member 101 can be inhibited as expeditiously as practical. According to the present embodiment, it is possible to enhance the air leakage efficiency or the liquid leakage efficiency at a joint portion between the metal surface 200 and the synthetic resin member 101 while achieving stronger and rigid bonding between the metal surface 200 and the synthetic resin member 101.

In particular, in the pressure sensor shown in FIG. 1, a fluid with a higher pressure may be generated in the measurement space 27. In this situation, a fault such as the intrusion of fluid to a resin metal joint facing the measurement space 27 or the leakage of fluid to outside of the pressure sensor 1 due to the deterioration of the air leakage efficiency or the liquid leakage efficiency may happen. The resin metal joint is, for example, a joint between the terminal member 31 and the resin portion 32 or a joint between the lead frame 41 and the resin case 43.

In this regard, in the present embodiment, the above-mentioned resin metal joint includes the joint structure shown in FIG. 2. Therefore, according to the present embodiment, when the pressure sensor 1 illustrated in FIG. 1 is used for measuring the pressure of a high-pressured fluid such as a common rail pressure or a brake fluid pressure, the satisfactory reliability can be attained.

(Modification)

The present disclosure is not limited to the embodiment described above and may be appropriately modified. Representative modifications will be described below. In the following description of modifications, only some parts different from the above-described embodiment will be described. In addition, in the above-described embodiment and the modifications, the same reference numerals are given to the same or equivalent parts. Therefore, in the description of the following modifications, regarding components having the same reference numerals as the components of the above-described embodiment, the description in the above-described embodiment can be appropriately cited unless there is a technical inconsistency or a specific additional explanation.

The configuration of the present disclosure is not limited to the above embodiment. For example, the configuration of the pressure sensor 1 is not limited to the particular example shown in the above embodiment.

That is, for example, a protective gel is filled into an accommodating recess 38 for covering the sensing part 4. In this situation, the pressure of the measured liquid is transmitted to the sensor element 42 through the protective gel as a pressure transmitting fluid. The protective gel is also one kind of “fluid.” Therefore, in this situation, the joint between the terminal member 31 and the resin portion 32 and the joint between the lead frame 41 and the resin case 43 may be referred to as “disposed so as to face the fluid.” Even in this configuration, the intrusion of the protective gel into the joint between the terminal member 31 and the resin portion 32 or the joint between the lead frame 41 and the resin case 43 can be inhibited as expeditiously as practical.

The configuration of the resin metal joint 100 may not be limited to the particular example shown in the above embodiment. For example, the metal portion 102 may be a metal member or a composite of a metal member and another member. That is, for example, the metal portion 102 may be a surface metal layer of the so-called SOI substrate. SOI is the acronym of “Silicon on Insulator.”

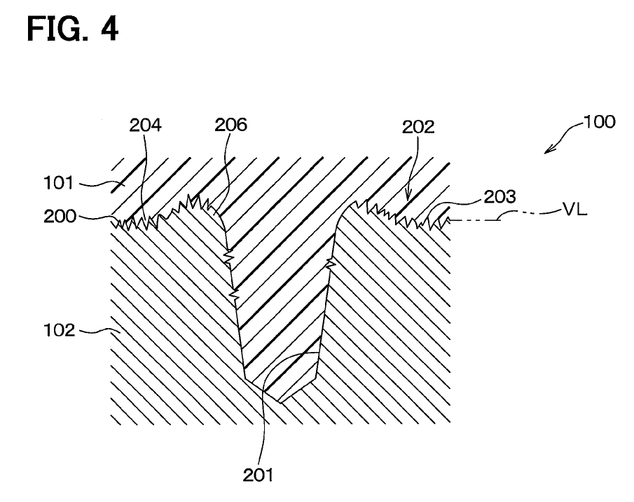

As shown in FIG. 4, the micro-protrusion portion 206 may also be formed at a position adjacent to the micro-recess portion 201. In this situation, the nano-asperity 203 may also be provided at the micro-protrusion portion 206 in addition to the flat portion 202. The synthetic resin material, which is for configuring the synthetic resin member 101, easily intrudes into the nano-recess portion 204 of the nano-asperity 203 of the micro-protrusion portion 206. Therefore, even when the nano-asperity 203 is provided on the micro-protrusion portion 206, it is difficult for voids to be formed on the nano-recess portion 204 of the micro-protrusion portion 206. Accordingly, even with such a configuration, it is possible to achieve stronger and rigid bonding between the metal surface 200 and the synthetic resin member 101 while improving air leakage efficiency or liquid leakage efficiency at the joint portion between the metal surface 200 and the synthetic resin member 101.

A plurality of configuration elements are integrally and seamlessly formed with each other as described above. However, the plurality of configuration elements may also be formed by means of bonding separate members. Similarly, a plurality of configuration elements, which are formed by means of bonding separate members, may also be integrally and seamlessly formed.

A plurality of configuration elements are formed by the same material as described above. However, the plurality of configuration elements may be also formed by different materials. Similarly, the plurality of configuration elements, which are formed by different materials, may also be formed by the same material.

Modified examples are not limited to the examples illustrated above. A plurality of modifications may be combined with each other. Furthermore, all or a part of the above-described embodiment and all or a part of the modifications may be combined with each other.

1. A resin metal joint as a joint between a metal surface and a synthetic resin member, the resin metal joint comprising:
a plurality of micro-recess portions at the metal surface, the micro-recess portions each being a recess portion of the metal surface having a depth in a micron order;
a flat portion, which is a section of the metal surface different from the micro-recess portions;
a plurality of nano-asperities at the metal surface, the nano-asperities each being a recess and a protrusion having a height or a depth in a sub-micron order or a nano order, wherein:
the micro-recess portion has a lower number of the nano-asperities than in the flat portion.

2. The resin metal joint according to claim 1, wherein:
the nano-asperities of the flat portion are taller than the nano-asperities of the micro-recess portion.

3. The resin metal joint according to claim 1, wherein:
the micro-recess portion has a lower density of the nano-asperities than in the flat portion.

4. The resin metal joint according to claim 1, wherein:
the micro-recess portion is in a substantially V-shape or a substantially U-shape in a cross-sectional view.

5. The resin metal joint according to claim 1, wherein:
the depth of the micro-recess portion is represented by D;
the micro-recess portion has an opening width represented by W; and
the micro-recess portion is provided to satisfy a relation of 1≤D/W≤5.

6. A pressure sensor generating an electrical output corresponding to a pressure of a fluid, the pressure sensor comprising:
a resin metal joint as a joint between a metal surface and a synthetic resin member, the resin metal joint provided to face the fluid, wherein:
the metal surface includes
a micro-recess portion as a recess portion having a depth in a micron order,
a flat portion different from the micro-recess portion, and
nano-asperities each is a recess and a protrusion having a height or a depth in a submicron order or a nano order; and
the micro-recess portion has a lower number of the nano-asperities than in the flat portion.

7. The pressure sensor according to claim 6, wherein:
the nano-asperities of the flat portion are taller than the nano-asperities of the micro-recess portion.

8. The pressure sensor according to claim 6, wherein:
the micro-recess portion has a lower density of the nano-asperities than in the flat portion.

9. The pressure sensor according to claim 6, wherein:
the micro-recess portion is provided in a substantially V-shape or a substantially U-shape in a cross-sectional view.

10. The pressure sensor according to claim 6, wherein:
the depth of the micro-recess portion is represented by D;
the micro-recess portion has an opening width represented by W; and
the micro-recess portion is provided to satisfy a relation of 1≤D/W≤5.
